(19) United States
(12) Patent Application Publication
(10) Pub. No.: US 2025/0367850 A1
(43) Pub. Date: Dec. 4, 2025

(54) STABLE MANUAL WOOD SPLITTER WITH A DETACHABLE BASE

(71) Applicant: Timmothy Wells, Vancouver, WA (US)

(72) Inventor: Timmothy Wells, Vancouver, WA (US)

(21) Appl. No.: 19/224,804

(22) Filed: May 31, 2025

Related U.S. Application Data
(60) Provisional application No. 63/654,919, filed on May 31, 2024.

(51) Int. Cl. B27L 7/06

(52) U.S. Cl. CPC B27L 7/06

(57) ABSTRACT

A wood splitter for splitting an upright log by controllably forcing a wedge directly down into the top of the log. The wood splitter includes: a base plate and a stop sleeve having a cross-sectional shape that is not round. The stop sleeve can be welded to the base plate, and a non-round rail can be inserted into the stop sleeve and removably attached thereto, or the non-round rail can be secured directly to the base plate. Also included is a wedge to receive impacts, and a lower cutting edge to be driven into the top of the log. A guide sleeve that is slidably threadable over the non-round rail also has a horizontal support beam to support the wedge over the center of the base plate. The guide sleeve is stable against pivoting about the non-round rail as a user hammers the wedge downward to split the log.

### CROSS REFERENCE TO RELATED APPLICATIONS

This application claims priority from U.S. Provisional Patent Application Ser. No. 63/654,919, filed May 31, 2024, and titled “Stable Manual Wood Splitter”, the disclosure of which is hereby incorporated by reference in its entirety.

### FIELD OF THE INVENTION

This invention relates generally to wood splitters, and more particularly to wood splitters that do not require electrical power or hydrocarbon fuel or hydraulic power.

### BACKGROUND OF THE INVENTION

Wood splitters exist that are powered electrically, pneumatically, and by gasoline powered engine, for example. However, such wood splitters are typically large, expensive, and not portable.

Wood splitters are also known that do not require external power, but are not stable in various ways. For example, a hard blow by a heavy hammer can impact at an angle, causing the axe head to rotate out of alignment, causing the log to be ejected laterally from the wood splitter, and allowing the axe head or the hammer head to come down upon a user's foot, resulting in serious injury.

### SUMMARY OF THE INVENTION

The invention is a device that can be used to safely split wood, and includes a wedge that rides up and down on a non-round rail or track or slot or guide.

The user hammers or hits or strikes or impacts the top of the wedge using a heavy hammer or heavy mallet.

The non-round rail is securely attached perpendicularly to a heavy metal plate for enhanced stability.

The heavy metal plate has stabilizing ridges or other surface features for preventing the bottom end of a log standing vertically from slipping laterally.

The non-round rail cooperates with a motion stop that abuts against the heavy metal plate to prevent the sharp end of the wedge from contacting the heavy metal plate.

The wood splitter requires no “log base”, because a metal plate is used instead, so no hardwood stump is needed. A metal plate provides more stability than a hardwood stump.

The wood splitter does not require power from electricity or gasoline or hydraulics.

A general aspect of the invention is a wood splitter for splitting a log having a top end and a bottom end, the log standing upright on the bottom end, the wood splitter forcing a wedge down into the top end. The wood splitter includes: a base plate; a non-round rail secured perpendicularly to the base plate, the non-round rail having a cross-sectional shape that is substantially not round; a wedge having an upper surface configured to receive impacts, and a lower cutting edge configured to split wood; and a guide sleeve substantially having the cross-sectional shape of the non-round rail, the guide sleeve rigidly attached to the wedge, the guide sleeve configured to slide upward and downward along the non-round rail without pivoting about the non-round rail as the wedge moves downward towards the log.

In some embodiments, the wood splitter further includes: a stop sleeve having a top end and a bottom end, the bottom end of the stop sleeve resting on the base plate,
the stop sleeve having the cross-sectional shape of the guide sleeve, the top end of the stop sleeve extending to a height along the non-round rail such that the bottom end of the guide sleeve will abut against the top end of the stop sleeve before the lower cutting edge of the wedge can impact the base plate.

In some embodiments, the base plate has surface features configured to prevent lateral slipping of the bottom of the log along the base plate.

In some embodiments, the base plate is square or rectangular, having four corner portions, and the non-round rail is secured perpendicularly to a corner portion of the base plate.

In some embodiments, the non-round rail has a cross-sectional shape that is substantially square.

In some embodiments, the top surface of the wedge is slightly convex.

In some embodiments, the guide sleeve is threaded over the non-round vertical rail.

In some embodiments, the support beam extends horizontally from the guide sleeve and rigidly supports the wedge over the base plate.

In some embodiments, the bottom end of the stop sleeve is welded to the base plate, the non-round rail is inserted into the stop sleeve until the non-round rail rests on the base plate, and the non-round rail is secured perpendicularly to the base plate by being removably secured to the stop sleeve.

In some embodiments, the stop sleeve includes at least one pair of holes through an opposing pair of sides of the stop sleeve, the non-round rail includes at least one pair of holes through an opposing pair of sides of the non-round rail, the at least one pair of holes through the stop sleeve align with a respective pair of holes through the non-round rail such that a respective threaded bolt can extend through the at least one pair of holes through the stop sleeve and through the respective pair of holes through the non-round rail, a threaded nut is threaded onto the threaded bolt and tightened, and the threaded bolt and tightened threaded nut together secure the non-round rail to the stop sleeve, thereby securing the non-round rail to the base plate.

Another general aspect of the invention is a wood splitter for splitting a log having a top end and a bottom end, the log standing upright on the bottom end, the wood splitter forcing a wedge down into the top end. This wood splitter includes: a base plate; a non-round rail welded perpendicularly to the base plate, the non-round rail having a cross-sectional shape that is not round; a stop sleeve having the cross-sectional shape of the non-round rail, and threaded onto the non-round rail until a bottom of the stop sleeve rests on the base plate; a wedge having an upper surface configured to receive impacts, and a lower cutting edge configured to split wood; and a guide sleeve having the cross-sectional shape of the non-round rail, and having a support beam configured to support the wedge, the guide sleeve slidably threaded over the non-round vertical rail, the support beam extending horizontally from the guide sleeve to rigidly support the wedge over a center of the base plate.

In some embodiments, the top end of the stop sleeve extends upward to a height along the non-round rail such that the bottom end of the guide sleeve must come to a stop when the top end of the stop sleeve abuts against the top end of the stop sleeve, thereby preventing the lower cutting edge of the wedge from reaching the base plate.

In some embodiments, the guide sleeve is configured to slide upward and downward along the non-round rail without pivoting about the non-round rail as the wedge moves downward towards the log.

Yet another general aspect of the invention is a wood splitter for splitting a log having a top end and a bottom end, the log standing upright on the bottom end, the wood splitter forcing a wedge down into the top end. This version of the wood splitter includes: a base plate; a stop sleeve having a cross-sectional shape that is not round, and having a top end and a bottom end, the bottom end welded to the base plate; a non-round rail having a cross-sectional shape that is not round, and sized to fit closely into the stop sleeve, the non-round rail configured to be removably attachable to the stop sleeve; a wedge having an upper surface configured to receive impacts, and a lower cutting edge configured to split wood; and a guide sleeve having the cross-sectional shape of the non-round rail, and having a support beam configured to support the wedge, the guide sleeve slidably threadable over the non-round vertical rail, the support beam extending horizontally from the guide sleeve to rigidly support the wedge over a center of the base plate.

In some embodiments, the guide sleeve is configured to not pivot about the non-round rail as the wedge moves downward towards the top of the log.

In some embodiments, the top end of the stop sleeve extends to a height along the non-round rail such that the bottom end of the guide sleeve must come to a stop when the top end of the stop sleeve abuts against the bottom end of the guide sleeve, thereby stopping a downward movement of the guide sleeve before the lower cutting edge of the wedge impacts the base plate.

In some embodiments, the base plate has surface features configured to prevent lateral slipping of the bottom of the log along the base plate.

In some embodiments, the base plate is square or rectangular, therefore having four corner portions, and the stop sleeve is secured perpendicularly to a corner portion of the base plate.

In some embodiments, the non-round rail has a cross-sectional shape that is substantially square.

In some embodiments, the stop sleeve includes at least one pair of holes on an opposing pair of sides of the stop sleeve, the non-round rail includes at least one pair of holes on an opposing pair of sides of the non-round rail, the at least one pair of holes through the stop sleeve aligning with a respective pair of holes through the non-round rail such that a respective threaded bolt can extend through the at least one pair of holes through the stop sleeve and through the respective pair of holes through the non-round rail, a threaded nut thereafter threaded onto the threaded bolt and tightened, the threaded bolt and tightened threaded nut together configured to secure the non-round rail to the stop sleeve, which has been welded to the base plate, thereby securing the non-round rail to the base plate.

### BRIEF DESCRIPTION OF THE DRAWINGS

Many additional features and advantages will become apparent to those skilled in the art upon reading the following description, when considered in conjunction with the accompanying drawings, wherein:

FIG. 1 is a perspective view of an embodiment of the wood splitter, showing the base plate with non-slip features, the non-round vertical rail secured perpendicularly to the base plate, the guide sleeve threaded over the non-round vertical rail and resting on the stop sleeve, the support beam extending horizontally from the guide sleeve and rigidly supporting the wedge over the center of the base plate.

FIG. 2 is a side view of a user placing a log centrally and vertically on the base plate, after positioning the guide sleeve, support beam, and wedge above the top of the log.

FIG. 3 is a side view of the user lowering the guide sleeve, support beam, and wedge over the top of the log until the cutting end of the wedge rests on the top of the log.

FIG. 4 is a side view of the user holding a large hammer or metal mallet for applying an impact downward upon the anvil end of the wedge while the cutting end of the wedge rests on the top of the log.

FIG. 5 is a side view of the user about to apply an impact downward upon the anvil end of the wedge using the large hammer or metal mallet, the guide sleeve still allowing the cutting end of wedge to rest on the top of the log.

FIG. 6 is a side view of the user in the act of applying the impact downward upon the anvil end of the wedge using the large hammer or metal mallet, the guide sleeve still in the position where the cutting end of wedge rests on the top of the log.

FIG. 7 is a side view of the user after applying the impact downward upon the anvil end of the wedge using the large hammer or metal mallet, causing the cutting end of wedge to move downward and split the log, while the guide sleeve moves downward until stopped by the stop sleeve, thereby preventing the cutting end of the wedge from impacting the base plate.

FIG. 8 is a side view of the user after applying the impact downward upon the anvil end of the wedge, the guide sleeve resting on the stop sleeve, the cutting end of the wedge safely supported above the base plate.

FIG. 9 is a perspective view of the embodiment of FIG. 1, showing only the base plate with the non-slip features, and the non-round vertical rail secured perpendicularly to the base plate by welding the bottom of the non-round vertical rail perpendicularly to the base plate.

FIG. 10A is a perspective view of parts of an alternate embodiment, showing the base plate with a stop sleeve welded to the base plate, the stop sleeve having two holes drilled front-to-back about one inch from the top of the stop sleeve 120, and two holes drilled side-to-side about two inches from the top of the stop sleeve.

FIG. 10B is a perspective view of another part of the alternate embodiment of FIG. 10A, showing the non-round vertical rail standing vertically by itself, and having two holes drilled front-to-back, and two holes drilled side-to-side near the bottom of the non-round vertical rail, such that both pairs of holes will align with the respective pairs of holes drilled in the stop sleeve when the bottom of the non-round vertical rail is inserted into the stop sleeve until it rests on the base plate.

FIG. 11 is a perspective view of the alternate embodiment of FIGS. 10A and 10B, showing the base plate with the stop sleeve welded to the base plate, also showing the non-round vertical rail inserted into the stop sleeve, such that the non-round vertical rail rests on the base plate within the stop sleeve, and with a bolt extending completely through each of the four holes, and secured by four respective threaded nuts, thereby securing the non-round vertical rail to the stop sleeve.

FIG. 12 is a perspective view of the alternate embodiment of FIG. 11, the non-round vertical rail removably inserted and secured within the stop sleeve that is welded to the base plate, the guide sleeve slidable up and down along the non-round vertical rail, and resting on the stop sleeve, also showing the base plate with non-slip features, the support beam extending horizontally from the guide sleeve and rigidly supporting the wedge over the center of the base plate.

### DETAILED DESCRIPTION

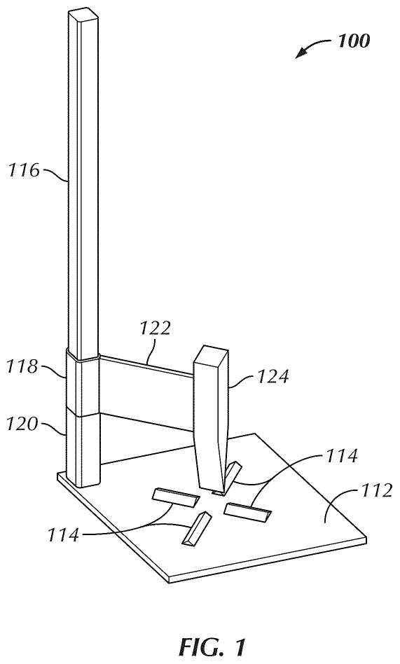

With reference to FIG. 1, an embodiment 100 of the wood splitter is shown that includes a base plate 112 with non-slip features 114. The non-slip features 114 can be the four ridges 114 as shown, or could be any surface features that resist lateral slipping of the bottom of a piece of wood, such as a regular array of pyramids (not shown). The non-round rail 116 is secured perpendicularly to the base plate 112, such as by welding, nuts and bolts, and/or brackets (not shown).

The guide sleeve 118 is threaded over the non-round rail 116 and is shown resting on the stop sleeve 120. The support beam 122 extends horizontally from the guide sleeve 118, and rigidly supports the wedge 124 over the center of the base plate 112.

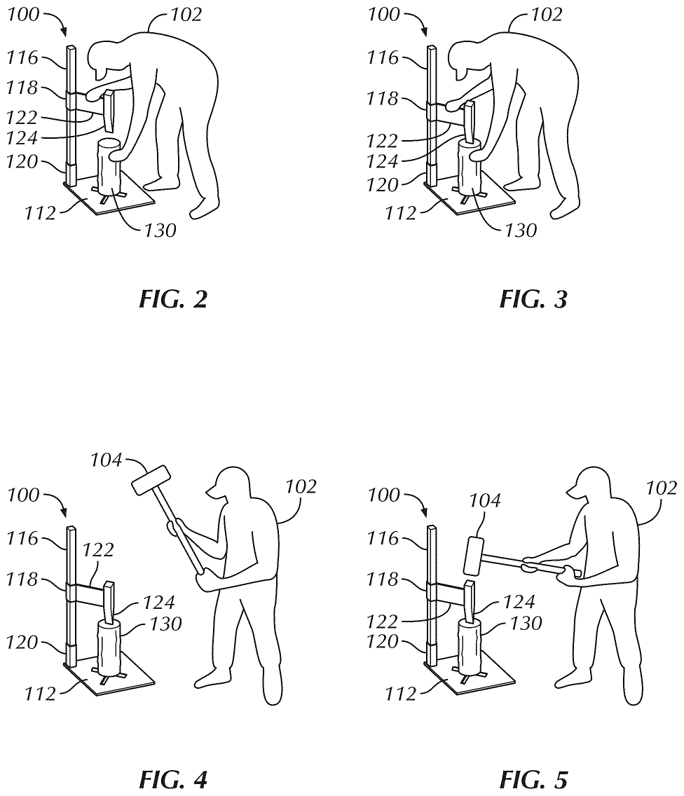

Referring to FIG. 2, a user 102 is shown placing a log 130 centrally and vertically on the base plate 112, after positioning the guide sleeve 118, support beam 122, and wedge 124 above the top of the log 130.

With reference to FIG. 3, the user 102 is shown lowering the guide sleeve 118, support beam 122, and wedge 124 over the top of the log 130 until the cutting end of the wedge rests on the top of the log 130.

Referring to FIG. 4, the user 102 is shown holding a large hammer or metal mallet 104 for applying an impact downward upon the top end of the wedge 124 while the cutting end of the wedge 124 rests on the top of the log 130.

With reference to FIG. 5, the user 102 is shown about to apply an impact downward upon the top end of the wedge 124 using the large hammer or metal mallet 104, the guide sleeve 118 still allowing the cutting end of wedge 124 to rest on the top of the log 130.

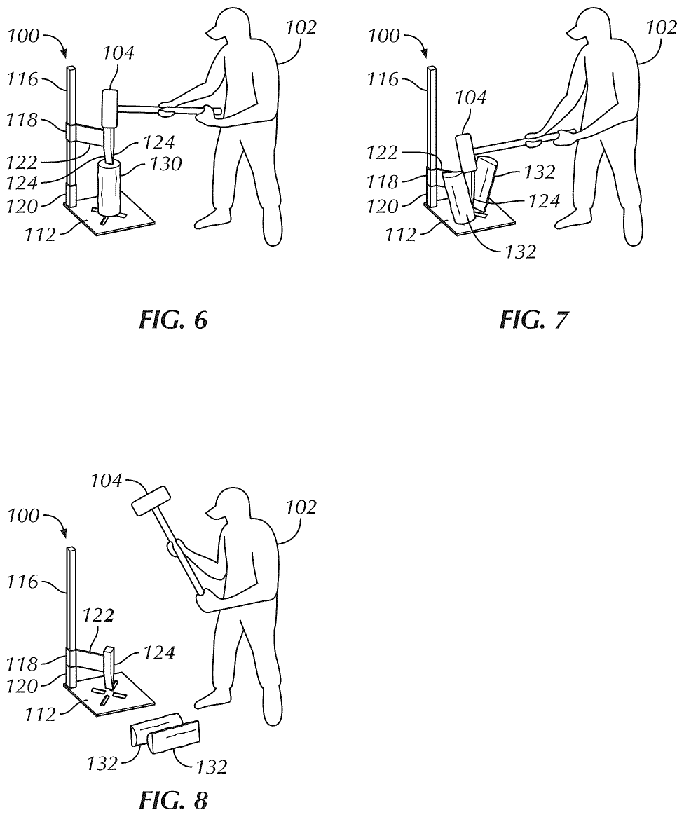

Referring to FIG. 6, the user 102 is shown in the act of applying the impact downward upon the top end of the wedge 124 using the large hammer or metal mallet 104, the guide sleeve 118 still in the position where the cutting end of wedge 124 rests on the top of the log 130.

With reference to FIG. 7, the user 102 is shown after applying the impact downward upon the top end of the wedge 124 using the large hammer or metal mallet 104, causing the cutting end of wedge 124 to move downward and split the log 130 into split logs 132, while the guide sleeve 118 moves downward until stopped by the stop sleeve 120, thereby preventing the cutting end of the wedge 124 from impacting the base plate 112.

Referring to FIG. 8, the user 102 is shown after applying the impact downward upon the top end of the wedge 124, the guide sleeve 118 resting on the stop sleeve 120, the cutting end of the wedge 124 safely supported above the base plate 112.

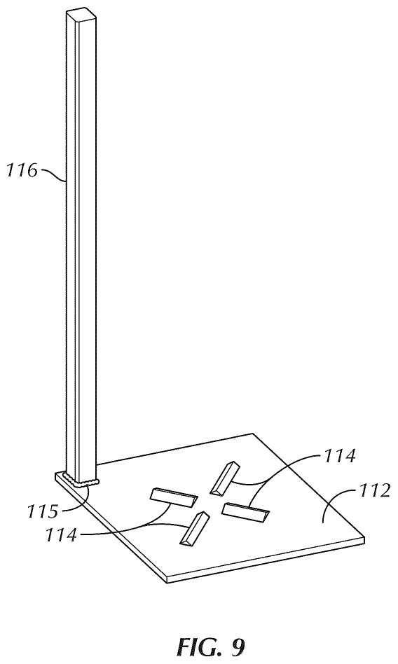

With reference to FIG. 9, the embodiment of FIG. 1 is further illustrated, showing only the base plate 112 with the non-slip features 114, and the non-round rail 116 secured perpendicularly to the base plate by a weld 115 around the bottom of the non-round rail 116.

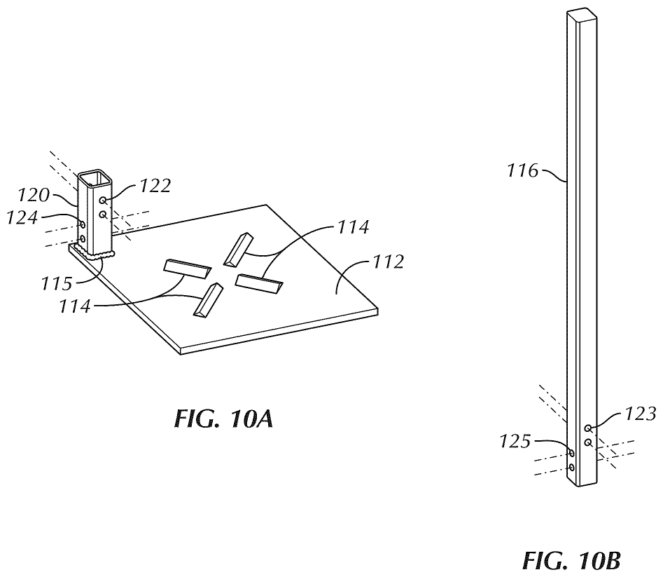

Referring to FIG. 10A, parts of an alternate embodiment are presented, wherein the stop sleeve 120 is welded 115 to the base plate 112 having the non-slip feature 114. Also, the stop sleeve 120 has at least two holes 122 drilled front-to-back about one inch from the top of the stop sleeve 120, and two holes drilled side-to-side about two inches from the bottom of the stop sleeve 120.

With reference to FIG. 10B, the non-round rail 116 is shown by itself standing vertically, and having two holes 123 drilled front-to-back, and two holes 125 drilled side-to-side near the bottom of the non-round rail 116, such that both pairs of holes 123 and 125 will align with the respective pairs of holes 122 and 124 drilled in the stop sleeve 120 when the bottom of the non-round rail 116 is inserted into the stop sleeve 120 until it rests on the base plate 112 so that the non-round rail 116 can be secured to the base plate 112 via the stop sleeve 120.

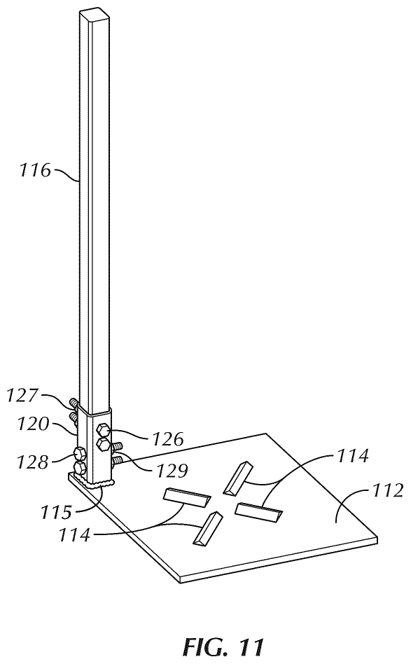

Referring to FIG. 11, the alternate embodiment of FIGS. 10A and 10B is shown, the base plate 112 with the stop sleeve 120 welded to the base plate 112, also showing the non-round rail 116 inserted into the stop sleeve 120, such that the non-round rail 116 rests on the base plate 112 within the stop sleeve 120. To secure the non-round rail 116 to the base plate 112 via the stop sleeve 120, bolt 126, 128 extend completely through each of the respective holes 122, 123, and are secured by at least two respective threaded nuts 127, 129, thereby securing the non-round rail 116 to the stop sleeve 120.

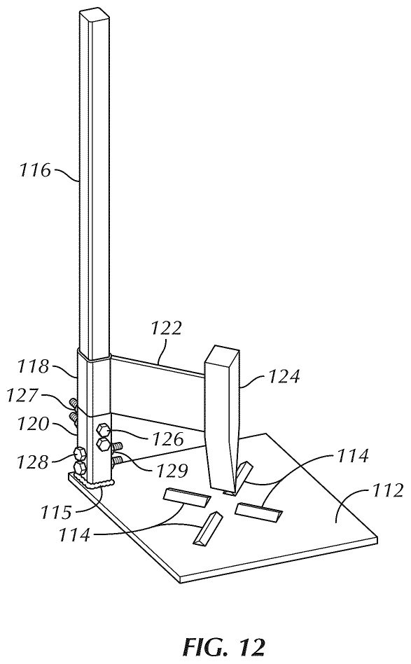

With reference to FIG. 12, the alternate embodiment of FIG. 11 is shown with the non-round rail 116 removably inserted and secured within the stop sleeve 120 that is welded to the base plate 112, the guide sleeve 118 slidable up and down along the non-round rail 116, and resting on the stop sleeve 120. Also shown is the base plate 112 with non-slip features 114, the support beam 122 extending horizontally from the guide sleeve 118, and rigidly supporting the wedge 124 over the center of the base plate 112.

In the first embodiment, as shown in FIGS. 1 and 9, the non-round rail 116 is welded 115 to the base 112, and the stop sleeve 120 is threaded onto the non-round rail 116 and allowed to rest on the base 112. The guide sleeve 118 is then threaded onto the non-round rail 116, and initially rests on the stop sleeve 120 until a piece of wood 130 is placed standing upright on the base 112 substantially at the center of the non-slip features 114, ready to be split.

By contrast, in the second embodiment, as shown in FIGS. 10A, 10B, 11, and 12, the stop sleeve 120 is welded 115 to the base plate 112, and the non-round rail 116 is inserted into the stop sleeve 120 until it rests on the base plate 112. Then, guide sleeve 118 is threaded onto the non-round rail 116 to initially rest on the stop sleeve 120 until a piece of wood 130 is placed standing upright at the center of the non-slip features 114 on the base plate 112, ready to be split.

To make the second embodiment of FIGS. 10A, 10B, 11, and 12 so that the non-round rail 116 is detachable from the base plate 112 (primarily to accommodate packing for transport), while also being securable to the base plate 112 to ensure safe use of the wood splitter:

First, weld 115 the stop sleeve 120 to the base plate 112.

Then, slide the non-round rail 116 into the stop sleeve 120 until the rail 116 rests on the base plate 112.

Next, drill two holes 122 front-to-back through the stop sleeve 120 about one inch from the top of the stop sleeve 120, and drill two holes 124 side-to-side through the stop sleeve 120 about two inches from the bottom of the stop sleeve 120. Two additional respective pairs of holes can be drilled and used for additional stability.

Then, drill two holes 123 front-to-back through the non-round rail 116 about four inches from the bottom of the non-round rail 116, and two holes 125 side-to-side through the non-round rail 116 about two inches from the bottom of the non-round rail 116. Two additional respective pairs of holes can be drilled and used for additional stability.

Next, insert the non-round rail 116 into the stop sleeve 120, and secure the non-round rail 116 to the stop sleeve 120 by inserting bolt 126 through the hole pairs 122 and 123, and bolt 128 through hole pairs 124 and 125.

Then, secure each bolt 126 and 128 using nuts 127 and 129, respectively, thereby securing the non-round rail 116 of FIG. 10B to the stop sleeve 120 of FIG. 10A. Preferably, use ½″ diameter Grade 8 bolts.

The embodiment of FIG. 12 is essentially the same as the embodiment 100 of FIG. 1, except the embodiment of FIG. 12 has the weld 115 where the stop sleeve 120 meets the base plate 112, and the at least two bolts 126 and 128 serve to removably secure the non-round rail 116 to the base plate 112.

### Exemplary Dimensions and Weights:

The inside dimensions of the stop sleeve 120 and the wedge 124 are each 1⅝″ square.

That equates to ⅛″ clearance between the non-round rail 116 and the guide sleeve 120.

The non-round rail 116 is 36 inches tall, and the base plate 112 is ½ inches thick, and when they are secured together, the overall height is 361/2 “.

The base plate 112 is 16” square.

The outside dimensions of the non-round rail 116 is 1½″ square.

The weight of the mallet 128 is 8 lbs.

The weight of the wedge 124 is 8 lbs.

The weight of the base plate 112 is 48 lbs.

The total weight of the wood splitter 100 is 60 lbs.

Other modifications and implementations will occur to those skilled in the art without departing from the spirit and the scope of the invention as claimed. Accordingly, the above description is not intended to limit the invention, except as indicated in the following claims.

What is claimed is:

1. A wood splitter for splitting a log having a top end and a bottom end, the log standing upright on the bottom end, the wood splitter forcing a wedge down into the top end, the wood splitter comprising:
a base plate;
a non-round rail secured perpendicularly to the base plate, the non-round rail having a cross-sectional shape that is substantially not round;
a wedge having an upper surface configured to receive impacts, and a lower cutting edge configured to split wood; and
a guide sleeve substantially having the cross-sectional shape of the non-round rail, the guide sleeve rigidly attached to the wedge, the guide sleeve configured to slide upward and downward along the non-round rail without pivoting about the non-round rail as the wedge moves downward towards the log.

2. The wood splitter of claim 1, further comprising:
a stop sleeve having a top end and a bottom end,
the bottom end of the stop sleeve resting on the base plate,
the stop sleeve having the cross-sectional shape of the guide sleeve, and
the top end of the stop sleeve extending to a height along the non-round rail such that the bottom end of the guide sleeve will abut against the top end of the stop sleeve before the lower cutting edge of the wedge can impact the base plate.

3. The wood splitter of claim 1, wherein the base plate has surface features configured to prevent lateral slipping of the bottom of the log along the base plate.

4. The wood splitter of claim 1, wherein:
the base plate is square or rectangular, having four corner portions, and
the non-round rail is secured perpendicularly to a corner portion of the base plate.

5. The wood splitter of claim 1, wherein the non-round rail has a cross-sectional shape that is substantially square.

6. The wood splitter of claim 1, wherein the top surface of the wedge is slightly convex.

7. The wood splitter of claim 1, wherein the guide sleeve is threaded over the non-round rail.

8. The wood splitter of claim 1, wherein the support beam extends horizontally from the guide sleeve and rigidly supports the wedge over the base plate.

9. The wood splitter of claim 2, wherein
the bottom end of the stop sleeve is welded to the base plate,
the non-round rail is inserted into the stop sleeve until the non-round rail rests on the base plate, and
the non-round rail is secured perpendicularly to the base plate by being removably secured to the stop sleeve.

10. The wood splitter of claim 9, wherein
the stop sleeve includes at least one pair of holes through an opposing pair of sides of the stop sleeve,
the non-round rail includes at least one pair of holes through an opposing pair of sides of the non-round rail,
the at least one pair of holes through the stop sleeve align with a respective pair of holes through the non-round rail such that a respective threaded bolt can extend through the at least one pair of holes through the stop sleeve and through the respective pair of holes through the non-round rail,
a threaded nut is threaded onto the threaded bolt and tightened, and
the threaded bolt and tightened threaded nut together secure the non-round rail to the stop sleeve, thereby securing the non-round rail to the base plate.

11. A wood splitter for splitting a log having a top end and a bottom end, the log standing upright on the bottom end, the wood splitter forcing a wedge down into the top end, the wood splitter comprising:
a base plate;
a non-round rail welded perpendicularly to the base plate, the non-round rail having a cross-sectional shape that is not round;
a stop sleeve having the cross-sectional shape of the non-round rail, and threaded onto the non-round rail until a bottom of the stop sleeve rests on the base plate;
a wedge having an upper surface configured to receive impacts, and a lower cutting edge configured to split wood; and
a guide sleeve having the cross-sectional shape of the non-round rail, and having a support beam configured to support the wedge, the guide sleeve slidably threaded over the non-round vertical rail, the support beam extending horizontally from the guide sleeve to rigidly support the wedge over a center of the base plate.

12. The wood splitter of claim 11, wherein the top end of the stop sleeve extends upward to a height along the non-round rail such that the bottom end of the guide sleeve must come to a stop when the top end of the stop sleeve abuts against the top end of the stop sleeve, thereby preventing the lower cutting edge of the wedge from reaching the base plate.

13. The wood splitter of claim 11, wherein the guide sleeve is configured to slide upward and downward along the non-round rail without pivoting about the non-round rail as the wedge moves downward towards the log.

14. A wood splitter for splitting a log having a top end and a bottom end, the log standing upright on the bottom end, the wood splitter forcing a wedge down into the top end, the wood splitter comprising:
a base plate;
a stop sleeve having a cross-sectional shape that is not round, and having a top end and a bottom end, the bottom end welded to the base plate;
a non-round rail having a cross-sectional shape that is not round, and sized to fit closely into the stop sleeve, the non-round rail configured to be removably attachable to the stop sleeve;
a wedge having an upper surface configured to receive impacts, and a lower cutting edge configured to split wood; and
a guide sleeve having the cross-sectional shape of the non-round rail, and having a support beam configured to support the wedge, the guide sleeve slidably threadable over the non-round rail, the support beam extending horizontally from the guide sleeve to rigidly support the wedge over a center of the base plate.

15. The wood splitter of claim 14, wherein the guide sleeve is configured to not pivot about the non-round rail as the wedge moves downward towards the top of the log.

16. The wood splitter of claim 14, wherein the top end of the stop sleeve extends to a height along the non-round rail such that the bottom end of the guide sleeve must come to a stop when the top end of the stop sleeve abuts against the bottom end of the guide sleeve, thereby stopping a downward movement of the guide sleeve before the lower cutting edge of the wedge impacts the base plate.

17. The wood splitter of claim 14, wherein the base plate has surface features configured to prevent lateral slipping of the bottom of the log along the base plate.

18. The wood splitter of claim 14, wherein
the base plate is square or rectangular, therefore having four corner portions, and
the stop sleeve is secured perpendicularly to a corner portion of the base plate.

19. The wood splitter of claim 14, wherein the non-round rail has a cross-sectional shape that is substantially square.

20. The wood splitter of claim 14, wherein
the stop sleeve includes at least one pair of holes on an opposing pair of sides of the stop sleeve,
the non-round rail includes at least one pair of holes on an opposing pair of sides of the non-round rail,
the at least one pair of holes through the stop sleeve aligning with a respective pair of holes through the non-round rail such that a respective threaded bolt can extend through the at least one pair of holes through the stop sleeve and through the respective pair of holes through the non-round rail,
a threaded nut thereafter threaded onto the threaded bolt and tightened, and
the threaded bolt and tightened threaded nut together configured to secure the non-round rail to the stop sleeve, which has been welded to the base plate, thereby securing the non-round rail to the base plate.
